(19) United States
(12) Patent Application Publication
(10) Pub. No.: US 2003/0118483 A1
(43) Pub. Date: Jun. 26, 2003

(54) Method for carrying out parallel reactions

(76) Inventors: Hans-Christian Militzer, Odenthal (DE); Benjamin Meseguer, Tarragona (ES); Oliver Kuhn, Odenthal (DE)

Correspondence Address: William C. Gerstenzang, NORRIS, McLAUGHLIN & MARCUS, P.A., 220 E. 42nd Street, 30th Floor, New York, NY, 10017, US

(21) Appl. No.: 10/278,113

(22) Filed: Oct. 22, 2002

(30) Foreign Application Priority Data
Nov. 15, 2001 (DE) 10156246.2

(51) Int. Cl. B01J 19/00

(52) U.S. Cl. 422/99; 422/102; 422/130; 422/131

(57) ABSTRACT

A method for carrying out parallel reactions in a reactor having a plurality of individual reaction chambers under elevated pressure, in which the chambers are filled in parallel or series with liquid and/or solid reactants, the chambers are sealed using a common seal, subsequently pressurized and the reaction is carried out. An individual lid with a plurality of self-closing openings is used as the seal for the chambers, at least one opening being assigned to each chamber.

The invention relates to a method for carrying out parallel reactions in a reactor with a plurality of individually equipped reaction chambers under elevated pressure, in which the chambers are filled in parallel or series with the liquid reactants, solid reactants or a combination thereof, the chambers are sealed using a common seal, subsequently pressurized and the reaction is carried out, wherein an individual lid with a plurality of self-closing openings is used as the common seal for the chambers, with at least one openings being in communication with each of said chambers.

### BACKGROUND OF THE INVENTION

Despite extensive mechanistic work, the development of catalytic reaction methods is still a substantially empirical field of endeavor even today. It involves an essentially iterative process in which with available knowledge a catalyst is used under the presumably best conditions to produce a desired product. Then, from the values obtained for activity and selectivity, attempts are made to find ways of potential improvement, which are employed in subsequent runs to optimize the parameters. The end point of such an iterative process is marked by reaching an optimum or by fulfilling economic or technical requirements. In high-pressure reactions, the high parallelization of such an iterative process is still a particular technical challenge today.

WO 00/09255 A2 discloses a block of 48 individual high pressure reactors, with individual temperature and pressure controls and a system for injecting liquids into the individual reactors. Similar 6-tuple high-pressure reaction blocks are also available on the market. These high-pressure reaction blocks are practically usable whenever the experimental variables are temperature and pressure (e.g. second screening phase).

When it is desired to vary other parameters in a first screening phase (e.g. substrates, catalysts, ligands, additives, solvents, concentration of educts, etc.), it would be desirable to be able to employ an available autoclave as a reaction space and, instead of carrying our one reaction at a time, being able to carry out several, in batches which are miniaturized, i.e. reduced in their reaction volume to the millilitre range, in parallel under exactly the same conditions (e.g. with respect to temperature and pressure).

The work by Gilbertson, S. R. and Wang, X., (Tetrahedron 1999, 55, 11609) presents the use of a Parr reactor as a space for 24 test tubes, which can be hydrogenated in the same way. With the same concept, 5-, 7- and 8-compact high-pressure reaction blocks with common temperature and pressure control have been developed and marketed.

From the cited prior art it is apparent that, for discriminant screening, there is a need to develop a larger reaction matrix (e.g. a 96-tuple microtitre plate) with a straight-forward and practicable device for closure of the reaction chambers.

It is an object of the invention to provide a method for carrying out faster reaction tests (screening) or the optimization of reactions under pressure, e.g. for hydrogenation, oxidation or hydrocarboxylation in parallel runs, using sensitive catalysts or reagents and which achieves reproducible results.

This object is achieved according to the invention by a method wherein reactor blocks (microtitre plates) with matching slotted stud lids, which open automatically to the reaction chambers when subjected to external pressure, permits complete and practicable handling of sensitive working substances under inert conditions up until the reaction.

### SUMMARY OF THE INVENTION

The invention accordingly relates to a method for carrying out parallel reactions in a reactor with a plurality of individually equipped reaction chambers, under elevated pressure, in which the chambers are filled in parallel or series with liquid and/or solid reactants, the chambers are sealed using a common seal, subsequently pressurized and the reaction is carried out, wherein said common seal is an individual lid with a plurality of self-closing openings. at least one of which communicates with each chamber.

### DETAILED DESCRIPTION

Materials for forming the reactor chambers are, for example, selected from the group consisting of polypropylene, polystyrene, polytetrafluoroethylene (PTFE), glass, borosilicate, steel and aluminium; preferably polypropylene

A microtitre plate is preferably used as the reactor.

An embodiment of the invention in which a studded lid made of an elastic material is used as the common seal, and in which cross-slits are provided as openings in the studs, is preferred.

Particularly preferably, an inert gas, in particular a noble gas or nitrogen, is used for the pressurization.

In a preferred embodiment, the pressurization takes place with the addition of a gas comprising one or more gaseous reactants.

Silicone, Teflon, polypropylene, Perbunan, ethylene vinyl acetate copolymers (EVA) or ethylene-propylene terpolymer (EPDM) rubber are particularly suitable as the material for the studded lid (i.e., the stud lid), especially preferably polypropylene or EVA.

The openings in the lid particularly preferably are in the form of cross-slits.

Examples of reactions (reactants) which are advantageously carried out in accordance with the invention include: hydrogenation (H₂), oxidation (O₂) and hydrocarboxylation (CO/H₂).

The pressurization is advantageously carried out in an autoclave, all the reaction chambers thereby being pressurizable simultaneously.

A variant of the method in which the reaction chambers are combined in a reaction block is also particularly preferred.

Carrying out high-pressure reactions e.g. in a 96-tuple reactor block with a stud lid demonstrates the following advantages:

higher screening efficiency, with up to 96 parallel tests

shorter preparation times

lower educt demand

inexpensive consumable materials

simple handling

matrix format compatible with parallel automatic analysis and documentation

good transferability to individual tests

Reactions in parallelized batches with volumes at the 1-ml scale permit fast and comprehensive screening of catalyst systems and reaction conditions for new tasks. With low material consumption, it is possible e.g. in a 96-tuple microtitre plate format to evaluate various substrates, catalysts, ligands, additives, solvents, concentrations etc. very quickly in an initial iterative screening. By upscaling to single-autoclave tests, the best reaction conditions for producing gram amounts of the desired compound are finally determined (e.g. chiral product). By this iterative screening, the most active and most selective catalyst-ligand systems and the best reaction conditions can now be determined in a few optimization stages and in an extremely efficient way, in a processing period of approximately 4-6 weeks, and valuable assistance can therefore be provided.

### BRIEF DESCRIPTION OF THE DRAWINGS

The invention will be explained in more detail below by way of example and with reference to the figures in which:

FIG. 1a shows two perspective views of a preferred embodiment of a common seal 11 with cross-slits 13

FIG. 1b shows multiwell reactor 10 including a plurality of reaction chambers 12.

FIG. 2a shows the location of reactions in a96-microtitre plate according to example 1.

FIG. 2b shows the location of reactions in a 24-microtitre plate according to example 2.

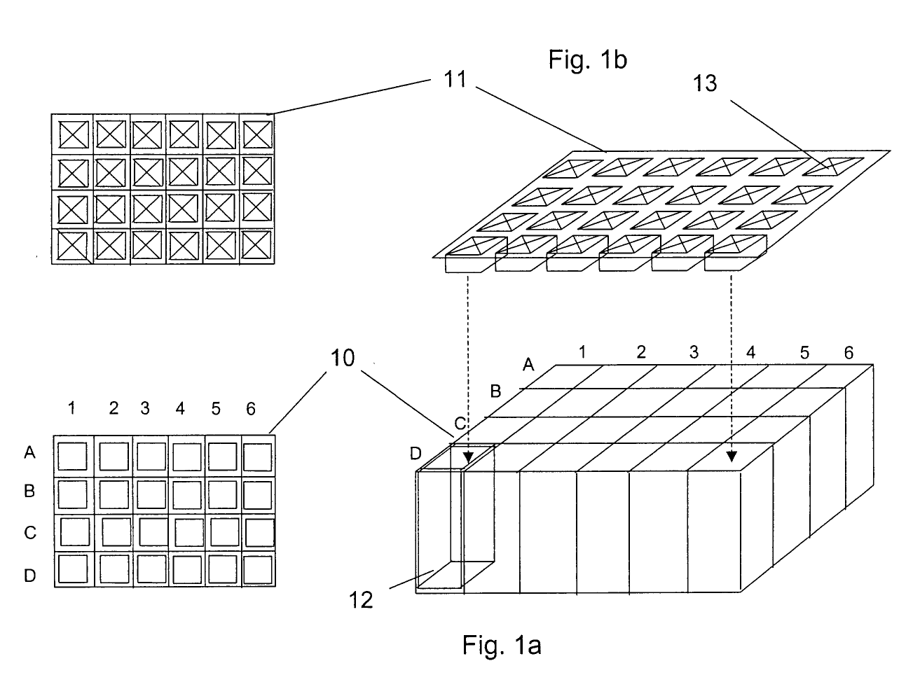

### EXAMPLES

### Example 1

Asymmetric Hydrogenation

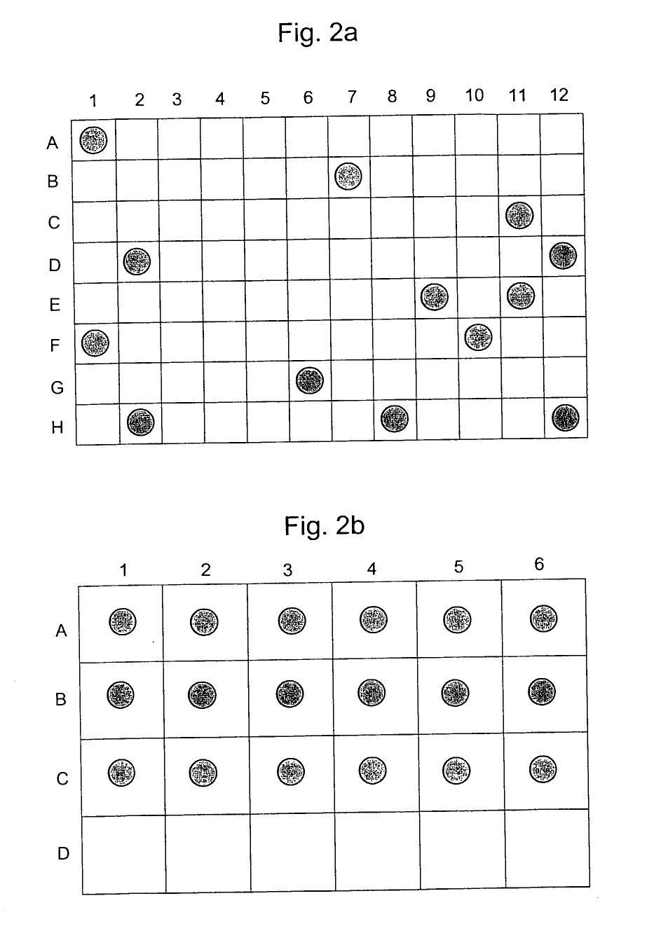

172.1 mg (1.20 mmol) of methyl 2-acetamidoacrylate and 11.2 mg (0.024 mmol) of bis(1,5-cyclooctadiene)rhodium(I) trifluoromethane sulphonate [Rh(COD)₂]SO₃ CF₃ were dissolved in 12.0 ml of degassed dry methylene chloride under argon and de-gassed. 8.1 mg (0.026 mmol) of (+)-1,2-Bis((25,5S)2,5-dimethylphosphono)benzene (S,S)-Me-DUPHOS were added and the mixture was stirred for 10 min. The yellow-orange solution was distributed in the absence of air (glove-box) over 13 (see FIG. 2a) positions of a microtitre plate 10 (“riplate SW” 2.5 ml-micro titerplate from HJ-Bioanalytik GmbH, material: Polypropylene) with 96 chambers, (containing 13 small magnetic fishes on the corresponding positions) closed with a matching slotted stud lid and hydrogenized in a suitable autoclave at 3 bar of hydrogen atmosphere and 25° C. for 24 h (with stirring). A stud in the lid with a cross-slit 13 was assigned to each segment of the microtitre plate. The mixtures were then filtered off and analyzed by GC.

TABLE 1

| Position in the | Enantiomer | Reaction conversion |
|---|---|---|
| 96-MTP | excess (%) | (%) |
| A1 | 92.75 | 55.62 |
| B7 | 91.15 | 49.37 |
| C11 | 93.13 | 47.17 |
| D2 | 93.97 | 62.76 |
| D12 | 93.74 | 50.98 |
| E9 | 94.21 | 54.86 |
| E11 | 91.16 | 47.93 |
| F1 | 91.48 | 49.33 |
| F10 | 93.62 | 63.36 |
| G6 | 92.74 | 64.25 |
| H2 | 93.60 | 54.32 |
| H8 | 91.06 | 52.33 |
| H12 | 90.32 | 42.97 |
| Mean | 92.53 | 53.48 |
| Deviation | 1.66 | 6.64 |

Table 1 clearly shows the reproducibility of the parallel reactions in arbitrary reaction chambers.

### Example 2

### Example 2

Allylic Oxidation

4.88 g (60 mmol) of 1,5-hexadiene and 268 mg (1.44 mmol) Pd(OAc)₂ were dissolved in 24 ml of acetic acid and provided with 612 mg (1.2 mmol) of acetic anhydride and 1212 mg (2.88 mmol) of iron-III nitrate and stirred for 20 min. In the absence of air (glove-box), the mixture was distributed over 16 positions (see FIG. 2b) of a microtitre plate with 24 chambers (“Uniplate® 24 Well, 10 ml from Whatman. Material: Polypropylene) closed with a slotted lid which matched it and was provided with studs, and oxidized in the matching autoclave at 20 bar of oxygen atmosphere and 40° C. for 12 h (without stirring). The mixtures were filtered off and analysed by GC.

TABLE 2

| Position in 24-MTP | Yield (% GC) |
|---|---|
| A1 | 31.7 |
| A2 | 37.1 |
| A3 | 38.6 |
| A4 | 39.7 |
| A5 | 37.0 |
| A6 | 38.5 |
| B1 | 37.2 |
| B2 | 36.9 |
| B3 | 32.2 |
| B4 | 32.6 |
| B5 | 35.9 |
| B6 | 35.7 |
| C1 | 32.6 |
| C2 | 36.4 |
| C3 | 39.6 |
| C4 | 35.6 |
| Mean | 34.13 |
| Standard deviation | 2.58 |

Table 2 again shows the reproducibility of the individual reactions in the parallel test.

We claim:

1. A method for carrying out parallel reactions in a reactor having a plurality of individual reaction chambers, at elevated pressure, which comprises feeding one or more liquid reactants, one or more solid reactants or a combination thereof into some or all of said chambers, in series or in parallel, sealing said chambers with a common seal, pressurizing said chambers and conducting said reactions in said chambers, wherein said common seal is an individual lid having a plurality of self-closing openings, with at least one of said openings communicating with each individual chamber.

2. Method according to claim 1, wherein said reactor is a microtitre plate.

3. Method according to claim 1 or 2, wherein said common seal is a studded lid made of elastic material, and said openings are cross-slits in the studs.

4. Method according to claim 1 or 2, wherein said pressurizing of said chambers is by an inert gas.

5. Method according to claim 4 wherein said inert gas is nitrogen or a noble gas.

6. Method according to claim 1 or 2, wherein said pressurizing of said chambers is by a gas which comprises one or more gaseous reactants.

7. Method according to claim 3, wherein said studded lid is made of a material selected from the group consisting of silicone, polytetrafluoroethylene, poly-propylene, Perbunan and EPDM rubber.

8. Method according to claim 1 or 2, wherein said pressurizing of said chambers and optionally said reaction is carried out with the reactor being within an autoclave.

9. Method according to claim 1 or 2, wherein the reaction chambers are combined in a reaction block.
